(19) United States
(12) Patent Application Publication
(10) Pub. No.: US 2025/0284136 A1
(43) Pub. Date: Sep. 11, 2025

(54) MULTIPLEX VIRTUAL DISPLAY SYSTEMS FOR MULTIPLE VIEWERS INCLUDING PRISMS WITH RELECTIVE AND TRANSMISSIVE SURFACES AND SECONDARY MIRRORS

(71) Applicant: GM GLOBAL TECHNOLOGY OPERATIONS LLC, Detroit, MI (US)

(72) Inventors: Tzvi Philipp, Bet Shemesh (IL); Thomas A. Seder, Fraser, MI (US); Manoj Kumar Sharma, Troy, MI (US); Joseph F. Szczerba, Grand Blanc, MI (US)

(21) Appl. No.: 18/600,277

(22) Filed: Mar. 8, 2024

(51) Int. Cl. G02B 27/28; G02B 27/00

(52) U.S. Cl. CPC G02B 27/283; G02B 27/0093

(57) ABSTRACT

A multiplexed virtual display system includes: a beam splitting device including i) a first surface configured to reflect a S polarized light beam to display a first image to a first observer and transparent to a P polarized light beam, and ii) a second surface configured to perform as a primary mirror and reflective to the P polarized light beam; a secondary mirror configured to reflect the P polarized light beam to display a second image to a second observer; and a projector configured to iteratively alternate between generating the S polarized light beam and the P polarized light beam.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to virtual image displays within a vehicle.

Display devices are used in a variety of applications. Some example display devices are flat panel displays, projection displays, and head-up displays. Display devices can be either of a transmission or reflection type. A vehicle may include multiple display devices to display various information to vehicle occupants (or observers). For example, some vehicles include an infotainment system that includes a display that displays various infotainment and other vehicle information.

### SUMMARY

A multiplexed virtual display system is disclosed and includes: a beam splitting device including i) a first surface configured to reflect a S polarized light beam to display a first image to a first observer and transparent to a P polarized light beam, and ii) a second surface configured to perform as a primary mirror and reflective to the P polarized light beam; a secondary mirror configured to reflect the P polarized light beam to display a second image to a second observer; and a projector configured to iteratively alternate between generating the S polarized light beam and the P polarized light beam.

In other features, the P polarized light beam passes through the first surface, is reflected off of the second surface, and is refracted by the first surface prior to being directed to the secondary mirror.

In other features, the first image is a same image as the second image.

In other features, the first image is a different image than the second image.

In other features, the beam splitting device includes a wedge-shaped prism including the first surface and the second surface.

In other features, the beam splitting device includes two separate distinct plates including a first plate having the first surface and a second plate having the second surface. An air gap exists between the first plate and the second plate.

In other features, the multiplexed virtual display system further includes at least one motor actuator assembly configured to move at least one of the first surface, the second surface and the secondary mirror.

In other features, the multiplexed virtual display system further includes: eye trackers configured to track at least one of locations and gaze directions of eyes of the first observer and the second observer; and a control module configured, based on the at least one of the locations and gaze directions of the eyes, to adjust at least one of location and orientation of at least one of i) the first surface, ii) the second surface, and iii) the secondary mirror.

In other features, the multiplexed virtual display system further includes: eye trackers configured to track at least one of locations and gaze directions of eyes of the first observer and the second observer; and a control module. The at least one motor actuator assembly including a first motor actuator assembly and a second motor actuator assembly. The first motor actuator assembly is configured to move the first surface. The second motor actuator assembly is configured to move the second surface relative to the first surface. The control module is configured, based on the at least one of the locations and gaze directions of the eyes, to adjust at least one of location and orientation of the first surface and the second surface.

In other features, the first motor actuator assembly is configured to move the first surface in X and Y directions. The second motor actuator assembly is configured to move the first surface in X and Y directions.

In other features, the multiplexed virtual display system further includes a liquid crystal phase plate configured to switch linear polarized light generated by the projector from S polarization to P polarization and from P polarization back to S polarization.

In other features, the secondary mirror includes a convex-shaped front surface and a flat back surface.

In other features, the beam splitting device is formed of glass. The second surface is a metallic surface.

In other features, the multiplexed virtual display system further includes a control module, where the projector includes a spatial light modulator and the control module is configured control the spatial light modulator to at least one of: implement a lens function to independently establish a virtual image distance for each of the first observer and the second observer; and encode a focal length for each of the first observer and the second observer into a respective one of multiple holograms for that viewer per frame.

In other features, the projector includes a light source, a spatial light modulator, a programmable polarizer, and projection optics and outputs multiple versions of the first image in multiple eye boxes to be viewed by the first observer and outputs multiple versions of the first image or the second image in multiple eye boxes to be viewed by the second observer.

In other features, a method is disclosed and includes: generating a S polarized light beam and a P polarized light beam via a projector, the projector iteratively alternating between the S polarized light beam and the P polarized light beam; directing the S polar light beam at a beam splitting device and the P polarized light beam to the beam splitting device followed by a secondary mirror; tracking values of at least one of locations and gaze directions of eyes of two occupants of a vehicle; determining locations and orientations of reflective surfaces of the beam splitting device and the secondary mirror based on the tracked values of the at least one of locations and gaze directions of the eyes; calculating expected image locations for the P polarized light beam and the S polarized light beam generated for two observers that are in different locations; calculating differences between the tracked values of the at least one of locations and gaze directions and expected values of the at least one of locations and gaze directions; and based on the differences, adjusting one or more of the locations and angles of the reflective surfaces.

In other features, the method further includes calculating expected image locations for the P polarized light beam and the S polarized light beam accounting for double refraction in an optical path of the P polarized light beam, a distance the S polarized light beam travels from the projector to a first occupant, and a distance the P polarized light beam travels from the projector to a second occupant. The two occupants include the first occupant and the second occupant.

In other features, the reflective surfaces include a first surface that reflects the S polarized light beam and transmits the P polarized light beam. A second surface reflects the P polarized light beam.

In other features, the method further includes, based on the differences, adjusting at least one of: orientation of the second surface relative to the first surface; and a reflective surface of the secondary mirror relative to the first surface.

In other features, the beam splitting device includes a wedge-shaped prism or multiple glass plates.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 functional block diagram of an example multiplexed virtual display system including a wedge-shaped prism and a secondary mirror implemented in a vehicle in accordance with the present disclosure;

FIG. 2 is a side view of another example prism having surfaces for reflecting

P polarized and S polarized light differently in accordance with the present disclosure;

FIG. 3 is a functional block diagram of another example multiplexed virtual display system including two independently positioned and oriented glass plates and a secondary mirror implemented in a vehicle in accordance with the present disclosure;

FIG. 4 is a functional block diagram illustrating eye tracking and feedback control using the two glass plates of FIG. 3 in accordance with the present disclosure;

FIG. 5 is a functional block diagram of an example projector including an optics assembly in accordance with the present disclosure;

FIG. 6 is a side view of an example prism and an example secondary mirror illustrating paths of light beams from a projector to two occupants in accordance with the present disclosure;

FIG. 7 is a perspective view of an example secondary mirror having a corrective characteristic for compensating for magnification effects of a primary mirror of a prism in accordance with the present disclosure;

FIG. 8 illustrates example views of light distribution seen at two occupants for two light beams following different length paths from a projector to the occupants;

FIG. 9 illustrates example views of light distribution seen at two occupants for two light beams following different length paths from a projector to the occupants where the P polarized light beam is over corrected in accordance with the present disclosure; and

FIG. 10 illustrates an example virtual display method for configuring a prism and a secondary mirror based on gaze directions of multiple occupants in accordance with the present disclosure.

In the drawings, reference numbers may be reused to identify similar and/or identical elements.

### DETAILED DESCRIPTION

In a shared vehicle where occupants are sitting in a “campfire” like arrangement facing each other, a user experience where each occupant is able to interact with one of multiple virtual displays may be provided. The virtual displays may appear by the occupants to project images that float in front of each occupant, for example, 1 meter away from each occupant. The occupants may interact with the displayed images by making gestures and/or providing voice commands. The imaging systems implement gesture recognition and voice recognition for received gestures and/or voice commands. The interaction may also be based on gaze directions (or angles) of the occupants, which may be determined using tracking cameras that track the gaze angles of the eyes of the occupants. When an occupant looks at a certain object in a virtual image, the system may provide certain information and/or respond based on the corresponding gaze angle of the occupant. Each virtual display of a vehicle can be expensive and relatively large.

The examples set forth herein include multiplexed virtual display systems for vehicle occupants (or observers). The multiplexed virtual display systems include beam splitting implementations such as single wedge-shaped prism implementations and a dual glass plate (or air wedge) implementation. The wedge-shaped prism implementations each includes a single prism with a glass body having a reflective backing (or primary mirror) and a preferential reflector. The prism of each implementation directs two multiplexed projection beams to two occupants. The occupants are facing in different directions (e.g., one occupant is facing forward and the occupant is facing rearward, thus the corresponding facing directions are 180° apart). The multiplexed projection beams are P linear polarized and S linear polarized beams, which are respectively reflected off the primary mirror and the preferential reflector. The preferential reflector is transmissive to P linear polarized light and reflective to S linear polarized light. The dual glass plate implementation includes two glass plates that are separated by an air gap. The first glass plate is transmissive to P linear polarized light and reflective to S linear polarized light. The second glass plate is reflective to the P linear polarized light. The two glass plates may split a beam into two orthogonally polarized beams. Relative positioning of the glass plates and the location and orientation of each of the dual glass plates may be independently controlled.

The systems disclosed herein allow each vehicle occupant to have an individualized viewing perspective that cannot be observed by other occupants in the vehicle. The systems also allow all or some of the occupants to share the same content. The individualized and shared viewing perspectives may be implemented for gaming applications, movie viewing applications, information providing applications, etc.

The disclosed systems minimize the number of image projectors (or display sources) and include display components associated with displaying images for multiple vehicle occupants. This reduces associated costs, number of components, and spatial (or volume) requirements (or the amount of space dedicated within a vehicle for display systems and components). The examples include use of a single projector to project images with the same or different content concurrently to multiple occupants. Images for the occupants are provided concurrently and may be viewed on independent virtual displays. The images originate from the same projector.

The examples disclosed herein may include a virtual three-dimensional (3D) display that projects real time “holograms” encoded via a computer and/or control module controlled spatial light modulator (SLM). A focus lens function is encoded and/or programmed into holograms of two images being concurrently displayed. The focus lens function independently establishes the virtual image distances (VIDs) respectively appropriate for the occupants. The focus lens function is a dynamic function that changes in time per frame and has the functionality of a lens. In other words, the encoded focal length for each occupant (or viewer) is encoded into the hologram for each viewer per frame. There is one lens function for each viewer. The VIDs and other information as described herein may be encoded into the holograms. The lens function adjusts the projected convergence of the light to compensate for the relative observation position (distance) of each viewer. Such a projection system enables the encoded projected information to be replicated per viewer to expand the viewing region or number of eye boxes visible for each viewer. This is achieved by filling a potential viewing region of an observer with multiple renderings of an image to be viewed by the observer independent of the viewing perspective or angle. The encoding can be further expanded to allow a subdivision of the encoding SLM, provided the SLM is large enough to maintain a target resolution to support multiple observers viewing different information. The generation of multiple (or replicated) eye boxes may be implemented as an alternative to or in combination with eye tracking and “steering” of reflective surfaces for each of the disclosed beam splitting implementations. The number of generated eye boxes may be adjusted based on the locations and lines of sight (or eye gaze directions) of the eyes of viewers and the locations and orientations of the reflective surfaces of the beam splitting device used. For example, the better the beams of light reflected are able to track the eye gaze directions of the eyes of the viewer, the fewer the number of eye boxes being generated.

The examples include use of a programmable linear polarizer that polarizes the outputs of each projector, where each viewing region is either in a P polarized linear state or in a S polarized linear state such that each channel has an orthogonal polarization state relative to the other channel. The P polarized linear channel is 90° out of phase from the S polarized linear channel.

The projectors are configured to alternate between linear polarization states and project linear polarized beams to a beam splitter that reflects S polarized light in a first direction to a first occupant, and transmits P polarized light in a second direction to a second occupant. The beam splitter may include a prism with two reflective surfaces (one being a preferential reflector and the other being non-preferential reflector (or primary mirror)) or two separate plates. The reflective surfaces of the prism are fixed relative to each other and may be moved together. A secondary mirror is used to redirect the P polarized light to the second viewer. The beam splitter and the secondary mirror allow concurrent and/or sequential viewing of content by multiple occupants. The orientation of the secondary mirror may be adjusted to direct content to different occupants.

The examples disclosed herein multiplex the outputs of virtual display sources to allow observers to view different content concurrently using a single projector. The examples disclosed herein include various features that may be used in combination or individually to achieve viewing of multiple images provided from a single projector by multiple occupants.

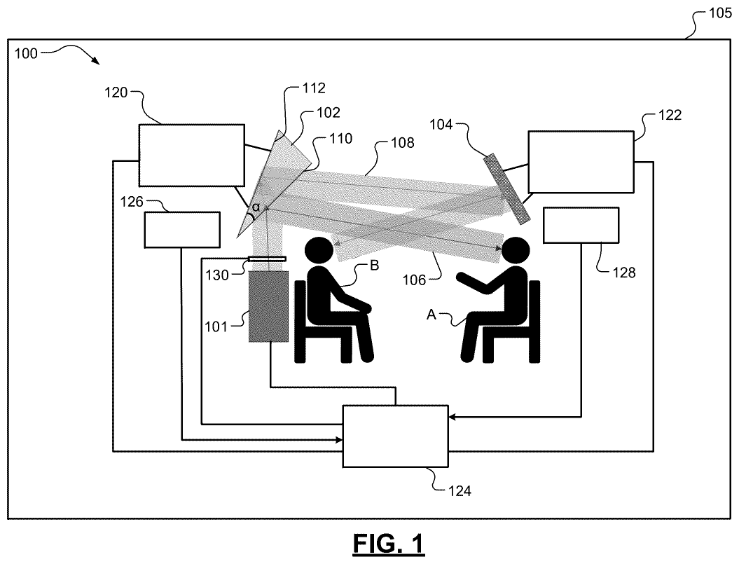

FIG. 1 shows an example multiplexed virtual display system 100 including a projector 101, a beam splitter implemented as a wedge-shaped prism (referred to as the prism) 102 and a secondary mirror 104. The system 100 may be implemented in a vehicle 105. The projector 101 alternates between projecting a first light beam 106 and a second light beam 108. The first light beam 106 is a P linear polarized beam. The second light beam 108 is a S linear polarized beam. The first light beam 106 is directed at an incident surface 110 of the prism 102 and is reflected and directed at a first occupant A.

The second light beam 108 is directed at the prism 102. At least a portion of the beam passes through the first (incident/output interface) surface (referred to as the preferential reflector) 110 and is refracted by the body of the prism 102. The refracted light is then reflected by a second (or back) surface (referred to as the primary mirror) 112 of the prism 102 and is again refracted at the incident/output interface surface 110 and directed at the secondary mirror 104. The back surface 112 is a reflective surface. The back of the prism 102 may include a metallic layer and/or coating that includes reflective material having the back surface 112. The second light beam is reflected off the secondary mirror 104 and is directed at a second occupant B. The back surface 112 is at an angle α relative to the incident surface 110.

The projector 101 emits each of the two light beams at least at 30 frames/second and thus emits light at least at 60 frames/second. The projector 101 may include a light source, a spatial light modulator, and a programmable liquid crystal phase plate, as further described below. See, for example, FIG. 5 and corresponding description thereof.

The system 100 may further include a first motor actuator assembly 120, a second motor actuator assembly 122, a control module 124, a first camera 126 and a second camera 128. The control module 124 may control operation of the actuator assemblies 120, 122 based on outputs of the cameras 126, 128. The cameras 126, 128 may track eye gaze angles of the occupants A, B and adjust the locations and orientations of the prism 102 and secondary mirror 104 to direct the light beams 106 and 108 at the eyes of the occupants A, B. The motor actuator assemblies 120, 122 may include motors, actuators, brackets, etc. and may biaxially adjust angles of the prism 102 and the secondary mirror 104. The cameras 126, 128 may also be used to detect gestures and/or gaze angles of the occupants A, B and determine based on this detection what information to provide to each of the occupants A, B. This holds true for other cameras disclosed herein.

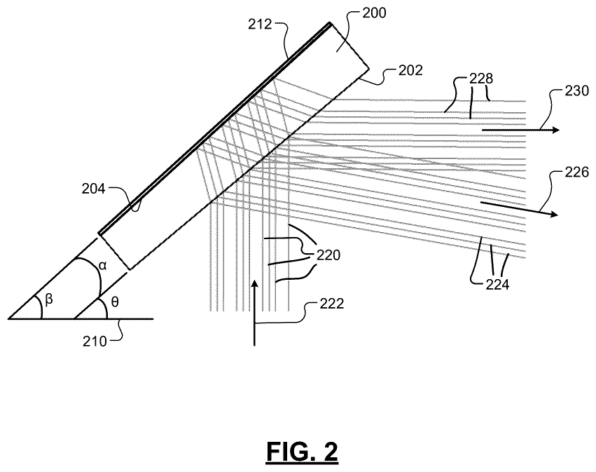

FIG. 2 shows a prism 200 having reflective surfaces 202, 204 for reflecting S polarized and P polarized light differently. The prism 200 may replace the prism 102 of FIG. 1. The reflective surfaces 202, 204 respectively reflect S polarized light and P polarized light. The reflective surface 202 is at an angle θ from a horizontal plane 210. The reflective surface 204, in the example shown, does not extend parallel to the reflective surface 202 but rather extends at a small angle α of for example 2-10° relative to the reflective surface 202. In one embodiment, the angle α is 2-3°. The reflective surface 204 is not parallel to the reflective surface 202. The reflective surface 204 may be at an angle β relative to the horizontal plane 210. The angle β is different than the angle θ. The reflective surface 204 may be provided by a reflective and/or metallic layer 212 on a back side of the prism 200.

The projector 101 of FIG. 1 is configured to have linear polarized light at the output. This can be achieved either by using lasers for the light output by using red, green, and/or blue lasers that are inherently polarized. Alternately, if the light sources of the projector 101 are not inherently polarized, then a polarizer may be added to the output of the projector 101. As an example, the polarizer may be a fixed polarization plate that defines the initial polarization of the illumination. The polarizer may be used for non-laser-based systems.

For all possible types of the projector 101, a liquid crystal phase plate 130 may be included at the output of the projector 101 that can switch the linear polarized light from S polarization to P polarization and from P polarization back to S polarization at a rate limited only by the switching time of the liquid crystal (e.g., 0.5-0.6 milliseconds (ms) at room (or ambient) temperature). The liquid crystal phase plate 130 adds the equivalent of a half wave of retardation to switch the linear polarization from S to P and ceases to add the equivalent of a half wave of retardation to switch from P to S. P polarization is defined as the orientation where the electric field of the incident light is parallel to the plane of incidence. S polarization is perpendicular to P polarization. The liquid crystal phase plate 130 may be integrated within the projector 101. The liquid crystal phase plate 130 is synchronized with and operates at the same frame rate as the projector 101.

The exit (or output) beam from the projector 101 is incident upon the prism 102, which may be a wedge polarized beam splitter (a single optical part). The prism 102 directs two polarized beams in different directions. This is controlled by the angles α and θ of the surfaces 110, 112 of the prism 102 and the index of refraction of the material n of the prism 102. The angle θ is the assembly angle for the entire prism 102. As an example, the angle α between the surfaces 110, 112 of FIG. 1 may be 2-10 degrees depending upon the design constraints of the system.

In FIG. 2, the surface 202 i) reflects S polarized light, and ii) transmits and refracts P polarized light. In FIG. 2, the surface 204 reflects P polarized light. Light output from a projector (e.g., projector 101 of FIG. 1) and passed through a liquid crystal phase plate (e.g., the liquid crystal phase plate 130 of FIG. 1) is incident on the surface 202 and represented by lines 220. The direction of the light 220 is indicated by arrow 222. Light reflected off of the surface 202 is represented by lines 224. The direction of the light 224 is represented by arrow 226. Light reflected off of the surface 204 and refracted by the surface 202 is represented by lines 228. Direction of the light 228 is represented by arrow 230.

The P polarized image at the occupant (or viewer) will have two optical artifacts that are addressed. There is some chromatic dispersion due to the prism 102 of FIG. 1 affecting on the transmitted and then refracted beam. This will appear in the image edges, one side edge being redder and the other side edge being bluer in the wedge direction of the prism 102. The second artifact is a distortion in the image size (compression) due to the prism relative to the reflected image along the vertical axis of the image. The chromatic dispersion may be addressed i) via the selection of the glass material of the wedged beam splitter, and/or ii) by addition of optics positioned along the P optical path and configured to compensate for the chromatic dispersion. The image compression may be addressed by applying a non-symmetric magnification to the image via image processing or optically as described below.

The S polarized beam is reflected towards the first viewer positioned opposite the prism 102. The P polarized beam is reflected towards the secondary mirror 104, which may be configured to reduce the stated image distortion of the image displayed for the second viewer positioned opposite the secondary mirror 104 and near the projector 101. The mirror 104 may be designed as a cylindrical reflector to correct for distortion along the y-axis. Also, warp maps may be applied to compensate for wedge position-induced image distortion.

A further modification of the projector 101 may be made to alter the output beam, which is composed of replications of eye boxes of a single viewer. At a desired (or target) frame rate the eye box replication is modified and synchronized with the polarization state of P or S to then project a different image to the viewer located to see the P polarized light versus the viewer positioned to see the S polarized light. The S and P holograms may be encoded with different lens functions to independently control the distances of the virtual images seen by the viewers.

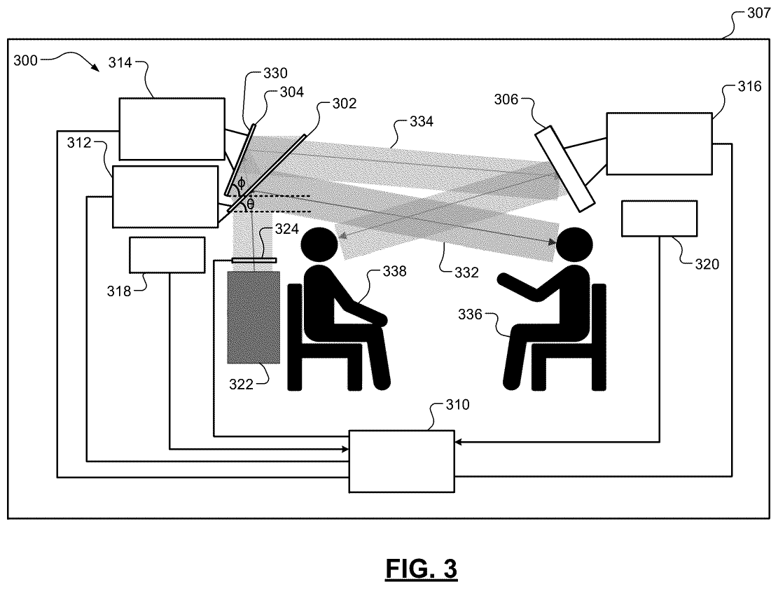

FIG. 3 shows a multiplexed virtual display system 300 including two independently positioned and oriented glass plates 302, 304 and a secondary mirror 306. The system 300 may be implemented in a vehicle 307. The two-plate design may exhibit less refraction than the designs of FIGS. 1-2 and thus have more optical power (or deflection) than the designs of FIGS. 1-2. The multiplexed virtual display system 300 further includes a control module 310, first, second and third motor actuator assemblies 312, 314, 316, first and second cameras 318, 320, a projector 322 and a liquid crystal phase plate 324, which may be integrated into the projector 322. The liquid crystal phase plate 324 is synchronized with and operates at the same frame rate as the projector 322.

The glass plates 302, 304 operate as a beam splitting device and replace the prism 102 of FIG. 1 and include low dispersion (or optical grade) glass. The glass plate 302 performs as a preferential reflector and is transmissive for P polarized light. The glass plate 304 has a reflective and/or metallic backing material (or coating) surface 330 that reflects P polarized light. The surface 330 may be referred to as the primary mirror. The S polarized light beam 332 and the P polarized light beam 334 are directed respectively at viewers 336, 338. The motor actuator assemblies 312, 314, 316 may include motors, actuators, brackets, etc. and are configured to position and orient the glass plates 302, 304, and the secondary mirror 306. The motor actuator assemblies 312, 314, 316 may biaxially adjust angles of the glass plates 302, 304 and the secondary mirror 306. This includes adjusting the angles θ, ϕ of the glass plates 302, 304 relative to horizontal or reference planes associated with the glass plates. The control module 310 may adjust these angles independently to follow gaze angles of observers and/or to minimize and/or reduce chromatic aberration. The P polarized light beam image is inverted and corrected due to the two-plate design.

The holograms generated and provided to the glass plates 302, 304 may be different to compensate for distances of observers from the projector. The distances being distances the P polarized light beam and the S polarized light beam follow from the projector to the observers. The distances may be programmed into the respective holograms. Various information may be programmed into the holograms including respective divergence angles due to the different lengths in paths (or distances). The information may be programmed such that the images seen by the observers are the same size and are perceived as being a same distance from each of the observers. A spatial light modulator, such as that shown in FIG. 5, may be used to generate hologram encoded images including the stated information including the distances, the divergent angles, etc. The data encoded by the SLM includes image data and the stated information.

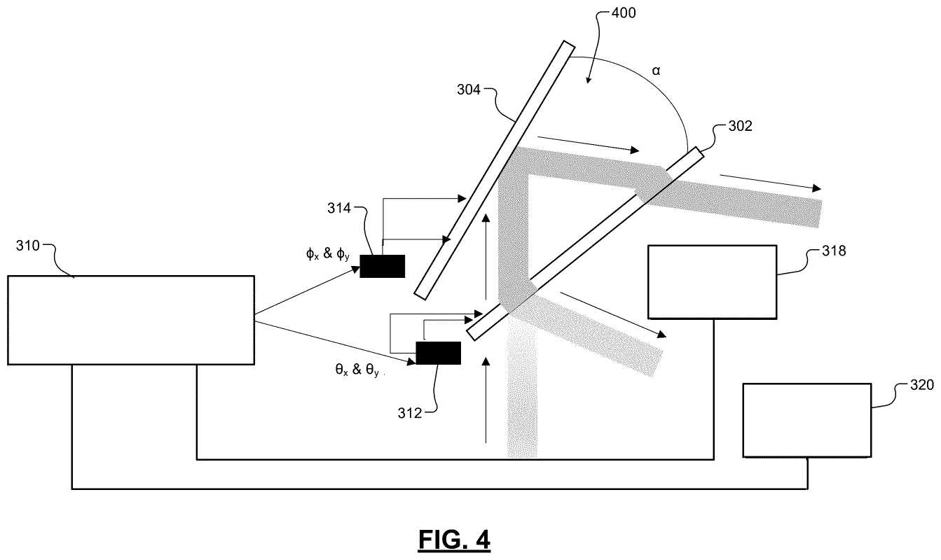

FIG. 4 shows eye tracking and feedback control using the two glass plates 302, 304 of FIG. 3. The control module 310 controls the position and orientation of the glass plates 302, 204 based on eye tracking signals from first and second eye trackers (e.g., cameras 318, 320) via the motor actuator assemblies 312, 314. The motor actuator assemblies 312, 314 adjust θₓ, θ_{y}, ϕₓ, ϕ_{y}.

The two planer (flat) beam splitters (or glass plates) 302, 304 are oriented with an air gap 400 between them with a tilt angle α between the plates. The air gap 400 varies in size along the plates 302, 304 when the plates 302, 304 are not parallel to each other. The plates 302, 304 may collectively be referred to as a beam splitting device.

The first plate (or glass plate) 302 may be coated to preferentially reflect S polarized light and transmit (or be transmissive to) P polarized light. The S polarized light is reflected towards the viewer positioned opposite the first plate beam splitter 302. The P polarized light is transmitted through the first plate 302 and is then reflected off a flat mirror or a dielectric coated substrate on the second plate 304. The second plate 304 thus performs as a mirror and reflects light towards the secondary mirror 306 of FIG. 3, which may be fixed or movable as shown.

The position and orientation of the plates 302, 304 may be adjusted relative to position and gaze directions of the viewers to maintain the viewing angle most suited for each viewer. Each of the plates may be mounted to respective tilt stages, which are moved by the motor actuator assemblies 312, 314, or may be directly mounted to the motor actuator assemblies 312, 314. The motor actuator assemblies 312, 314 may be two-stage (adjust tilt angles of each plate 302, 304 about multiple axes) or three-stage actuators (adjust X, Y and Z positions of each of the plates 302, 304 and tilt angles of each of the plates 302, 304 about multiple axes). This is accomplished based on feedback from the cameras 318, 320.

FIG. 5 shows a projector 500 that includes a light source 502 (e.g., a laser), a spatial light modulator (SLM) 504, and an optics assembly 506. A control module 508 (e.g., one of the control modules 124, 310 of FIGS. 1 and 3) controls states of the SLM 504 and the optics assembly 506. The optics assembly 506 may include a programmable polarizer, projection optics, and/or a programmable liquid crystal phase plate.

FIG. 5 is a simplified view of the projector 500 in a time sequential configuration. Each frame of the SLM 504 is directed to one viewer and the overall array of projected replicated eye boxes is steered in a different direction and configured to a different linear polarization state. Subsequently, the beam via the wedge prism 102 of FIG. 1 or the two-plate design of FIG. 3 may be directed for each polarized state (S and P) from the corresponding beam splitting device in a different direction. The beam splitting device is not shown in FIG. 5. The SLM 504 may be operated at two times (2X) a frame rate (e.g., 30 frames/second). Different images A and B respectively for the two viewers may be alternatively projected and concurrently displayed. In FIG. 5, a representative eye box projection (or region) 510 is shown including replicated eye boxes, which are represented as replicated versions of image A of a biker displayed multiple times per frame and at different angles to accommodate movement and/or different gaze angles of the corresponding viewer. In an embodiment, multiple eye boxes are not generated. This may occur when eye tracking is implemented. In another embodiment, eye tracking is performed in combination with generation of multiple eye boxes. The eye tracking may be done to optimize a number of eye boxes generated. The viewer sees only one of the eye box images of the biker at any moment in time. Oval 512 represents the viewer's eye. Each viewer may see a respective computer processed image.

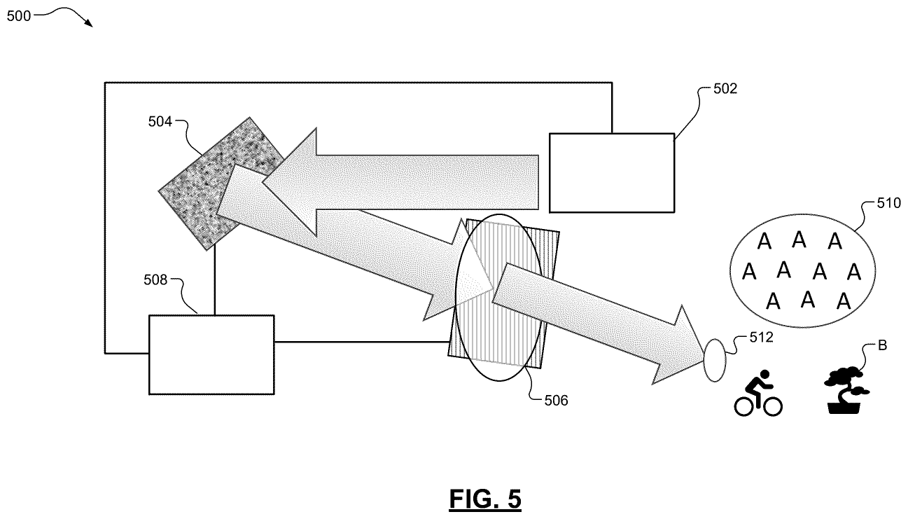

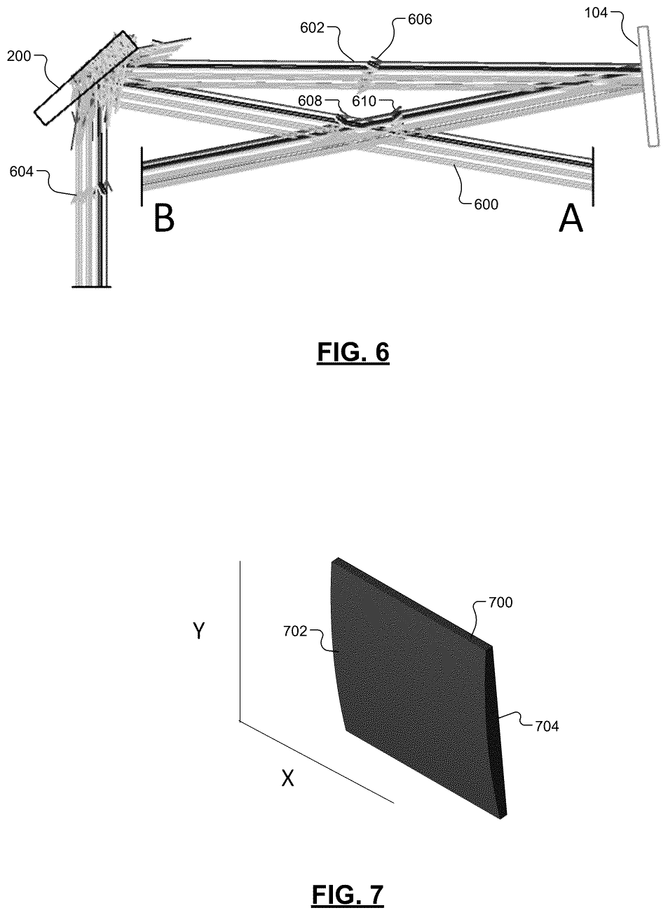

FIG. 6 shows the prism 200 of FIG. 2 and the secondary mirror 104 illustrating paths of light beams 600, 602 from a projector to two occupants A, B. Lenses, represented by cross-hatching lines 604, 606, 608, 610, may be disposed in the paths of the beams 600, 602. In an embodiment, one or more of the lenses are not included. The secondary mirror 104 may be used as a corrective mirror to compensate for magnification effects on the P polarized light beam caused by the prism 200.

FIG. 7 shows an example secondary mirror 700 having a corrective characteristic for compensating for magnification effects of a primary mirror of a prism. The secondary mirror 700 may replace any of the secondary mirror referred to herein. The secondary mirror 700 includes a front convex reflective surface 702 and a back flat surface 704. The front convex reflective surface 702 is used to reflect light received from a prism and/or primary mirror (e.g., the prism 102 or 200 of FIGS. 1-2 and/or the primary mirrors 112, 204, and 304 of FIGS. 1-3). The back flat surface 704 is not used to reflect light.

The radius of curvature of the convex surface 702 is along the Y axis and not along the X axis. Although shown as being curved in the Y axis direction, the front convex surface 702 may also be curved in the X axis direction such that the front convex surface 702 is shaped to be more like the shape of a portion of a sphere.

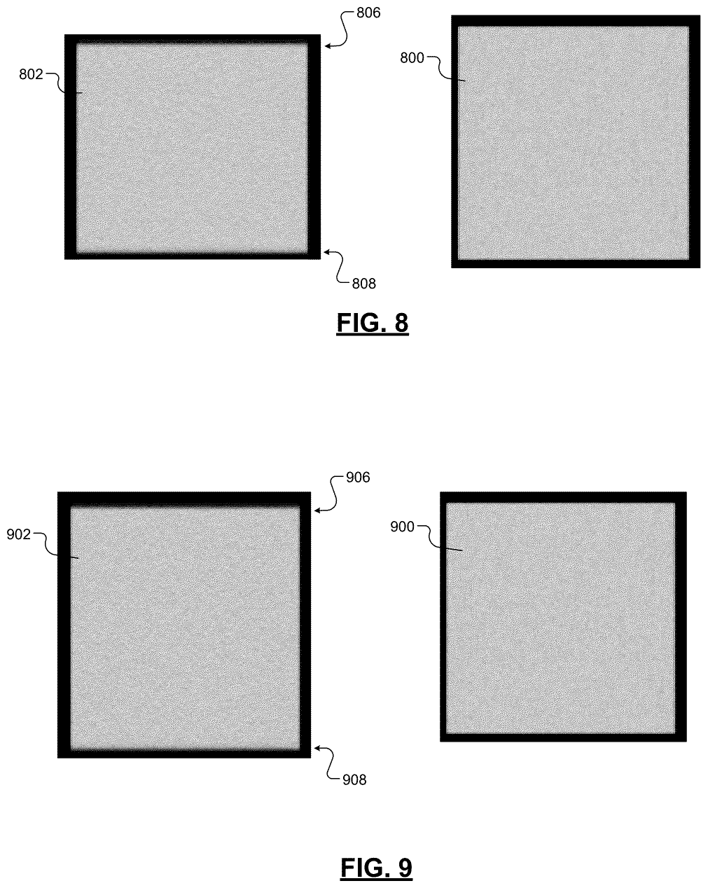

FIG. 8 shows example views of light distribution seen at two occupants for two light beams following different length paths from a projector to the occupants. These views may be provided using the prism 102 of FIG. 1 or the prism 200 of FIG. 2. As an example, the light distribution as seen by viewer A, which is opposite the prism, is represented by image 800. The altered version of the same image but as seen by viewer B, which is opposite the secondary mirror, is represented by image 802. Due to the prism, there is distortion effects such that the image 802 is smaller than the image 800 and there is also chromatic dispersion near upper and lower edges 806, 808.

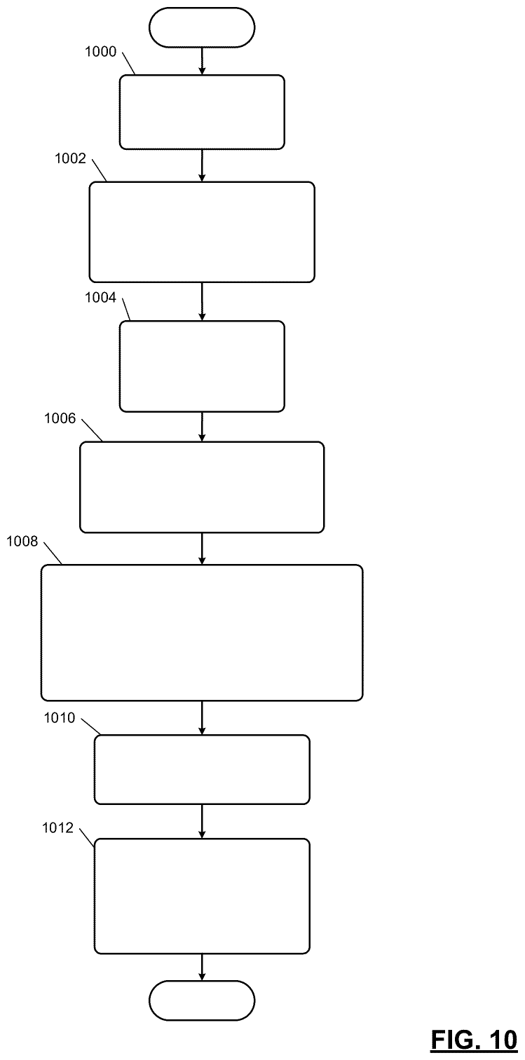

FIG. 9 shows example views of light distribution seen at two occupants for two light beams following different length paths from a projector to the occupants where the P polarized light beam is over corrected via the secondary mirror 700 of FIG. 7. As an example, the light distribution as seen by viewer A, which is opposite the prism, is represented by image 900. Due to the prism, there is distortion effects and chromatic dispersion near upper and lower edges 906, 908. The secondary mirror 700 however compensates for the distortion effects. In this example, the secondary mirror 700 overcompensates for the distortion effects by over magnifying the image in the Y direction, as represented by image 902. The secondary mirror 700 may be altered to however simply compensate for the distortion effects such that the result image is the same size as the image 900. For example, the curvature of the surface 702 may be reduced (i.e., more planar than shown in FIG. 7).

FIG. 10 shows a method for configuring a prism and a secondary mirror based on gaze directions of multiple occupants. The following operations may be iteratively performed. The operations may be performed by any of the projectors, eye trackers (or cameras), and control modules referred to herein.

At 1000, the projector generates a S polarized light beam and a P polarized light beam as described above. The projector iteratively alternates between the S polarized light beam and the P polarized light beam.

At 1002, the projector directs the S and P polarized light beams at a beam splitting device, as described above with respect to at least FIGS. 1-3. The P polarized light beam is then directed at a secondary mirror as described above with respect to at least FIGS. 1 and 3.

At 1004, the eye trackers detect locations and current eye gaze directions of the eyes of the occupants. At 1006, the control module determines locations and orientations of reflective surfaces of the beam splitting device and the secondary mirror based on the current locations and orientations of the reflective surfaces. This may include determining the X, Y, and Z locations of the reflective surfaces and associated angles such as angles α, β, θ, θₓ, θ_{y}, ϕₓ, ϕ_{y} referred to above.

At 1008, the control module calculates expected image locations for P polarized and S polarized light beams generated for multiple observers that are in different locations accounting for: i) double refraction in optical path of P polarized light beam, ii) distance between projector and observer of the P polarized light beam, and iii) distance between projector and observer of the S polarized light beam. This may include calculating, based upon first order ray tracing (paraxial) equations i_{1;2}=i_{0y;x}+θ_{y;x}*Z_{1;2}, the expected image location (y_{1;2}) from each reflective surface (y₀). This may include taking into consideration double refraction in optical path for the P polarized beam and the detected distance to the observer (z_{1;2}). The calculation may be based on ray tracing in air, where the index of refraction is n=1, otherwise the equation is modified by 1;2/n, where the angles of refraction are determined using Snell's equation of n₁sin θ0₁=n₂sin θ₂.

At 1010, the control module calculates differences between current values of eye trackers and expected values of the expected image locations.

At 1012, the control module adjusts one or more of the stated angles and/or locations of one or more of the reflective surfaces and/or location and orientation of the secondary mirror to minimize errors and provide best views of images to the occupants. This is based on the locations and eye gaze directions of the occupants and the differences determined at 1010. This may include positioning the reflective surfaces and the secondary mirror such that the generated light beams are in the lines of sight of the viewers and are directed at and/or are parallel to the lines of sight (or viewing directions) of the viewers.

The examples disclosed herein include: a virtual image projector configured with linear polarization output; a virtual image projector configured with a linear polarization output and a voltage controlled half wave phase plate that allows alternating the linear polarization stated between P and S at a frame rate twice as fast than that of the projector; a wedged prism beam splitter to divert the P and S projected beams into two independent directions that allow for simultaneous viewing; and a wedged air gap beam splitter made of two plate beam splitters, where the first beam splitter reflects S polarized light, and transmits P polarized light. The second plate reflects P polarized light, which may be implemented as a mirror.

The examples include a virtual image projection display configured to project simultaneously to two viewers independent images by alternating the projection polarization stated between P and S at a frame rate at least twice as high as the refresh rate (e.g., 30 frames/second) of the projector. In an embodiment, the output of the projector is directed towards a wedged beams splitter to separate the S polarized light from the P and direct each polarization towards a different viewer. Orientation control of reflection surfaces is provided to aim the hologram at different viewers. The time sequential S and P holograms are encoded to have a different lens function to control the distance of the virtual image. The disclosed distance viewing function receives input from eye tracking devices to calculate the viewing distance.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information, but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A multiplexed virtual display system comprising:
a beam splitting device comprising
a first surface configured to reflect a S polarized light beam to display a first image to a first observer and transparent to a P polarized light beam, and
a second surface configured to perform as a primary mirror and reflective to the P polarized light beam;
a secondary mirror configured to reflect the P polarized light beam to display a second image to a second observer; and
a projector configured to iteratively alternate between generating the S polarized light beam and the P polarized light beam.

2. The multiplexed virtual display system of claim 1, wherein the P polarized light beam passes through the first surface, is reflected off of the second surface, and is refracted by the first surface prior to being directed to the secondary mirror.

3. The multiplexed virtual display system of claim 1, wherein the first image is a same image as the second image.

4. The multiplexed virtual display system of claim 1, wherein the first image is a different image than the second image.

5. The multiplexed virtual display system of claim 1, wherein the beam splitting device comprises a wedge-shaped prism comprising the first surface and the second surface.

6. The multiplexed virtual display system of claim 1, wherein:
the beam splitting device comprises two separate distinct plates including a first plate having the first surface and a second plate having the second surface; and
an air gap exists between the first plate and the second plate.

7. The multiplexed virtual display system of claim 1, further comprises at least one motor actuator assembly configured to move at least one of the first surface, the second surface and the secondary mirror.

8. The multiplexed virtual display system of claim 7, further comprising:
a plurality of eye trackers configured to track at least one of locations and gaze directions of eyes of the first observer and the second observer; and
a control module configured, based on the at least one of the locations and gaze directions of the eyes, to adjust at least one of location and orientation of at least one of i) the first surface, ii) the second surface, and iii) the secondary mirror.

9. The multiplexed virtual display system of claim 7, further comprising:
a plurality of eye trackers configured to track at least one of locations and gaze directions of eyes of the first observer and the second observer,
wherein
the at least one motor actuator assembly comprising a first motor actuator assembly and a second motor actuator assembly,
the first motor actuator assembly configured to move the first surface, and
the second motor actuator assembly configured to move the second surface relative to the first surface; and
a control module configured, based on the at least one of the locations and gaze directions of the eyes, to adjust at least one of location and orientation of the first surface and the second surface.

10. The multiplexed virtual display system of claim 9, wherein:
the first motor actuator assembly is configured to move the first surface in X and Y directions; and
the second motor actuator assembly is configured to move the first surface in X and Y directions.

11. The multiplexed virtual display system of claim 1, further comprising a liquid crystal phase plate configured to switch linear polarized light generated by the projector from S polarization to P polarization and from P polarization back to S polarization.

12. The multiplexed virtual display system of claim 1, wherein the secondary mirror comprises a convex-shaped front surface and a flat back surface.

13. The multiplexed virtual display system of claim 1, wherein:
the beam splitting device is formed of glass; and
the second surface is a metallic surface.

14. The multiplexed virtual display system of claim 1, further comprising a control module, wherein the projector comprises a spatial light modulator and the control module is configured control the spatial light modulator to at least one of:
implement a lens function to independently establish a virtual image distance for each of the first observer and the second observer; and
encode a focal length for each of the first observer and the second observer into a respective one of a plurality of holograms for that viewer per frame.

15. The multiplexed virtual display system of claim 1, wherein the projector comprises a light source, a spatial light modulator, a programmable polarizer, and projection optics and outputs multiple versions of the first image in multiple eye boxes to be viewed by the first observer and outputs multiple versions of the first image or the second image in multiple eye boxes to be viewed by the second observer.

16. A method comprising:
generating a S polarized light beam and a P polarized light beam via a projector, the projector iteratively alternating between the S polarized light beam and the P polarized light beam;
directing the S polar light beam at a beam splitting device and the P polarized light beam to the beam splitting device followed by a secondary mirror;
tracking values of at least one of locations and gaze directions of eyes of two occupants of a vehicle;
determining locations and orientations of reflective surfaces of the beam splitting device and the secondary mirror based on the tracked values of the at least one of locations and gaze directions of the eyes;
calculating expected image locations for the P polarized light beam and the S polarized light beam generated for two observers that are in different locations;
calculating differences between the tracked values of the at least one of locations and gaze directions and expected values of the at least one of locations and gaze directions; and
based on the differences, adjusting one or more of the locations and angles of the reflective surfaces.

17. The method of claim 16, further comprising calculating expected image locations for the P polarized light beam and the S polarized light beam accounting for double refraction in an optical path of the P polarized light beam, a distance the S polarized light beam travels from the projector to a first occupant, and a distance the P polarized light beam travels from the projector to a second occupant,
wherein the two occupants comprise the first occupant and the second occupant.

18. The method of claim 16, wherein:
the reflective surfaces comprise a first surface that reflects the S polarized light beam and transmits the P polarized light beam; and
a second surface that reflects the P polarized light beam.

19. The method of claim 18, further comprising, based on the differences, adjusting at least one of:
orientation of the second surface relative to the first surface; and
a reflective surface of the secondary mirror relative to the first surface.

20. The method of claim 16, wherein the beam splitting device comprises a wedge-shaped prism or a plurality of glass plates.
